(19) United States
(12) Patent Application Publication
(10) Pub. No.: US 2004/0230665 A1
(43) Pub. Date: Nov. 18, 2004

(54) Mapping uniform resource locators to object classes and methods

(75) Inventors: Qiwei Xiao, Bolingbrook, IL (US); Alvin Barshefsky, Naperville, IL (US); Richard Allen Peterson JR., Grayslake, IL (US); Ning Xu, Aurora, IL (US)

Correspondence Address: Richard J. Minnich, Fay, Sharpe, Fagan, Minnich & McKee, LLP, Seventh Floor, 1100 Superior Avenue, Cleveland, OH, 44114, US

(73) Assignee: Lucent Technologies Inc

(21) Appl. No.: 10/436,816

(22) Filed: May 13, 2003

(51) Int. Cl. G06F 15/16

(52) U.S. Cl. 709/217

(57) ABSTRACT

Fields of a URL include class and method names or identifiers. An application root includes directory structure information for accessing a class associated with the class name or identifier. The application root also acts as a flag directing a server to process the URL to extract the class and method identifiers and to provide a requested resource based on the extracted class and method names or identifiers.

### BACKGROUND

The invention is related to the art of accessing object-oriented resources. The invention will be described in terms of Java-based resources. However, the invention may be applied in other object-oriented environments.

Referring to FIG. 1, conventionally, a universal or uniform resource locator (URL) 110 includes a protocol identifier 114, a server identifier 118, a port identifier 122 and a plurality of fields 126. For example, the protocol identifier 114 can identify a hypertext transfer protocol (HTTP), a file transfer protocol (FTP), a telnet protocol, or other protocol. In general, the fields 126 are mapped to elements of a file system of a server associated with the server identifier 118. For example, the fields 126 identify directories, subdirectories and/or file names associated with information stored on the server. For instance, a last field in a URL is most likely mapped to a static file, a file containing a common gateway interface (CGI) script, a file containing a servlet or a JSP/ASP name.

In object-oriented environments, this mapping can be inconvenient. The mapping requires that each resource stored on the server be stored in a separate file. However, in object-oriented environments, methods are generally stored grouped together within object class files. Each method may be considered a separate resource. Therefore, in object-oriented environments, it is common to store a plurality of resources in a single file. The conflict between the inclusion of a plurality of methods or resources within a single file, and the general structure of a URL requiring that each resource be in a separate file can lead to certain inefficiencies.

For instance, in some Java environments, in addition to generating and storing the desired object class and methods in a single file, system developers must also generate and store a plurality of programs, such as, for example, servlets for accessing the methods. A client desiring a method or output of a method transmits a URL identifying a servlet. The servlet is associated with the desired method, and only the desired method. The server invokes the servlet, and the servlet, in turn, provides the desired access to the desired method from within its associated object class.

This complicates system development and maintenance. In addition to creating or installing the desired object class and methods, a system developer must also create or install and maintain a plurality of servlets associated with the methods.

Therefore, there is a desire for a more efficient method for mapping URLs to object-oriented methods.

### SUMMARY

A procedure operative to provide a resource includes receiving, from a client, a URL requesting the resource, interpreting a first component of the URL as an object class identifier associated with an object class, interpreting a second component of the URL as a method identifier associated with a method of the object class, accessing the object class based on the object class identifier, retrieving the method associated with the method identifier from the object class, and providing the requested resource based on the retrieved method.

For example, interpreting the first component of the URL can include interpreting a first component of the URL as a Java object class identifier. Interpreting the second component can include interpreting the second component of the URL as a Java method identifier. Accessing the object class can include opening a file including the object class, the object class including a plurality of methods of the object class. Alternatively, accessing the object class can include other access means. For example an object class may be stored in Read-Only Memory (ROM) or on a networked device. In those cases accessing the object class may include memory reads, or network transfers. Providing the requested resource can include invoking the retrieved method, and returning output of the method to the client.

The process can also include recognizing an application root of the URL to be a flag directing the invocation of a handler program operative to analyze the URL.

Some embodiments include a process for providing a client access to information in a server system through a network, the network using a HyperText Transport Protocol. The process can include storing a Java object class including a plurality of Java methods in the server system, receiving a URL from the client, the URL including a name of the Java object class and a name of a Java method, invoking a Java method associated with the name of the Java method, and returning output of the method to the client.

Invoking the Java method can include instantiating the Java object class associated with the name of the Java object class and executing the Java method.

The process can also include recognizing a flag or switch within the URL and invoking a handler program based on the recognized flag or switch.

A server operative to provide an object-oriented resource to a client can include a URL parser, a resource retriever and a resource provider. For instance, the URL parser can be operative to extract an object class identifier component and a method identifier component from a URL received from a client. The resource retriever can be operative to receive the object class identifier and the method identifier from the URL parser, open an object class associated with the object class identifier and retrieve a method associated with the method identifier from among a plurality of methods in the opened object class. The resource provider can be operative to receive the retrieved method from the resource retriever and invoke the method, thereby providing the object oriented resource to the client.

For instance the URL parser can be operative to extract a Java object class identifier component and a Java method identifier component from the received URL. The resource retriever can be operative to receive a Java object class identifier and a Java method identifier from the URL parser, open a Java object class file associated with the Java object class identifier and retrieve a Java method associated with the Java method identifier from among a plurality of Java methods in the opened Java object class file.

The resource provider can be operative to receive the retrieved method from the resource retriever, invoke the method, and transmit output of the method to the client.

### BRIEF DESCRIPTION OF THE DRAWINGS

The invention may take form in various components and arrangements of components, and in various procedures and arrangements of procedures. The drawings are only for purposes of illustrating preferred embodiments, they are not to scale, and are not to be construed as limiting the invention.

FIG. 1 illustrates the structure of a universal or uniform resource locator (URL).

FIG. 2 illustrates the structure of a URL for use in accessing an object-oriented resource.

FIG. 3 illustrates a more general form of the URL of FIG. 2.

FIG. 4 and FIG. 5 illustrate specific examples of URLs conforming to the structure illustrated in FIG. 2 and FIG. 3.

FIG. 6 is a flow chart outlining an exemplary embodiment of a method operative to provide a resource or provide a client access to information.

FIG. 7 is a block diagram of a system operative to perform the method of FIG. 6.

### DETAILED DESCRIPTION

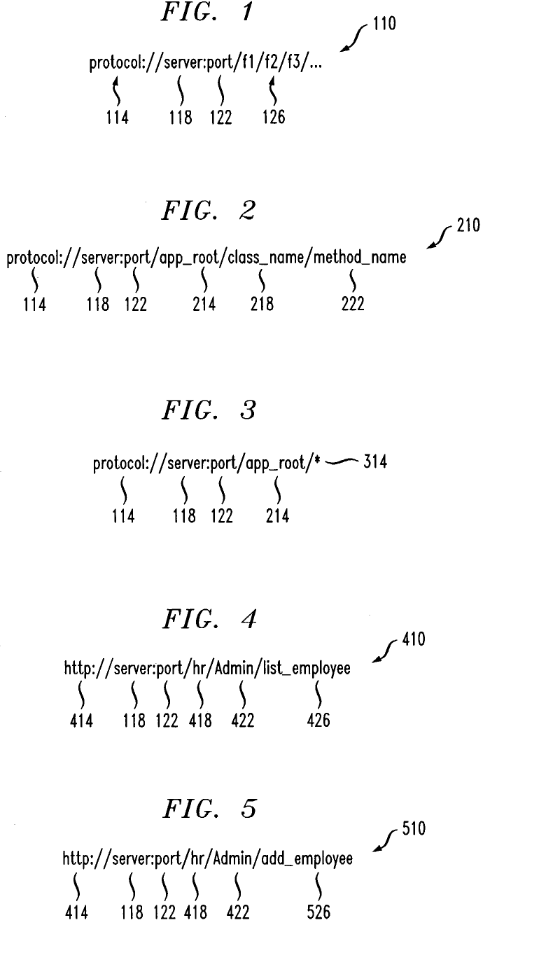

Referring to FIG. 2, a new URL format 210 includes the protocol identifier 114, the server identifier 118, the port identifier 122, as well as an application root identifier 214, a class name 218 and a method name 222. The application root 214 is a component of the URL 210 that can be used to identify a path to an object class associated with the class name component 218 of the URL 210. The application root may include a plurality of fields, such as, for example, the fields 126 of FIG. 1. Additionally, the application root 214 component may be used as a switch or flag signaling to a server (associated with the server identifier 118) that a special control or handler program should interpret the remaining components 218, 222 of the URL 210.

For example, referring to FIG. 3, the setup of a web server or a Java servlet container can be such that any URL including a predefined application root 214 is handled by a single controller program or handler. The controller program or handler examines the remaining fields (symbolized by the wildcard * 314 in FIG. 3) and extracts a class name and method name components (e.g., 218, 222). The controller program then provides the resource requested by the client. For example, the controller or handler program invokes a method associated with the method name 222 and a class associated with the class name 218.

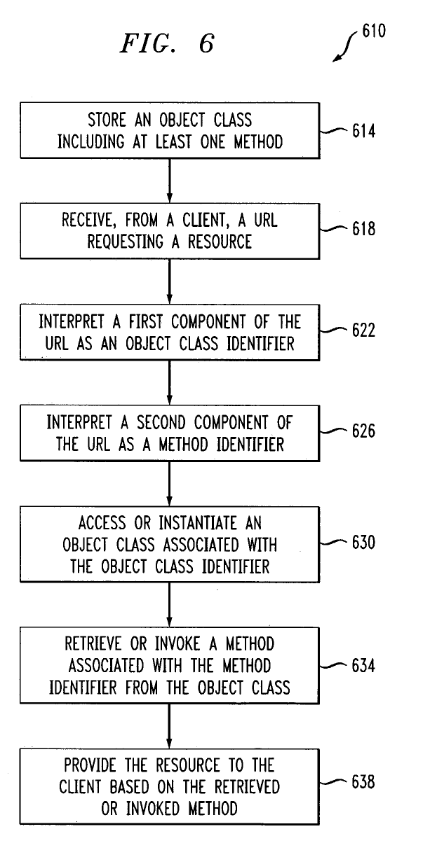

For example, referring the FIG. 4 and FIG. 5, a human resources web page may include links or URLs 410, 510. The first URL 410 is for requesting a list of employees. The second URL 510 is for invoking a method for adding employees to the list. Both URLs include an HTTP protocol identifier 414 as well as server 118 and port 122 identifiers. Additionally, the URLs 410, 510 include an application root (hr 418) and a class or identifier name (admin 422). However, the URLs 410, 510 include different method name or identifier components. The first URL 410 includes a method identifier of “list_employee.” The second URL 510 includes a method identifier “add_employee” 526.

In the example related to FIG. 4 and FIG. 5, a server associated with the server ID 118 or, for example, a Java servlet associated with that server, recognizes the application root hr 418 as a flag indicating that a controller or handler program should be invoked to interpret the remaining portions 422, 426 or 526 of the URLs 410 or 510. For example, a user views the web page with a web browser or client application. The user clicks on a symbol, which results in the transmission of the first URL 410 from the client to the server. The server recognizes the application root, hr 418, as a flag indicating that a control program should be invoked to interpret remaining components 422, 426 of the URL 410. The control program accesses or instantiates the class associated with the class identifier admin 422. Once the admin class is instantiated, the method associated with the list_employee 426 method identifier is invoked. The output of that method is transmitted to the client. For example, a list of employees is transmitted to the client.

If the user clicks on a second symbol, the second URL 510 is transmitted to the server. Again, the application root hr 418 is recognized as a flag for invoking the control program. The control program examines the second URL 510 and recognizes or interprets a first component of the URL admin 422 to be an object class identifier and recognizes or interprets a second component of the URL, add_employee 526, to be a method name or identifier. Therefore, the control program instantiates the class associated with the class name admin 422 and executes a method associated with the method name add_employee 526. Referring to FIG. 6, in summary, a method 610 for providing an object-oriented resource or for providing a client access to information in a server system can include storing 614 an object class including at least one method, receiving 618 a URL requesting a resource, interpreting 622 a first component of the URL as an object class identifier, interpreting 622 a second component of the URL as a method identifier, accessing or instantiating 630 an object class associated with the object class identifier, retrieving or invoking 634 a method associated with the method identifier from the object class and providing 638 the requested resource to the client based on the retrieved or invoked method.

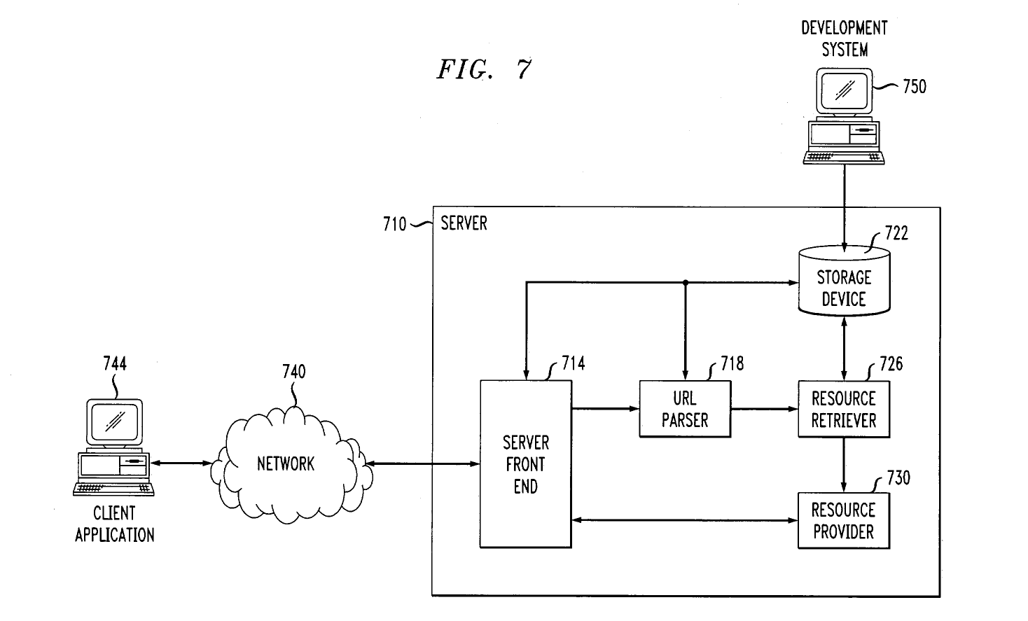

For example, storing 614 the object class may be part of a server development or web site maintenance procedure. For instance, procedures for generating dynamic web pages are stored as methods of an object class. Another web page may include links for accessing the dynamic web page by invoking the methods. A client, such as a web browser, may be used to select one or more of the links. For instance, a user uses a mouse to click on a function name or other icon representing the method. As a result, the client transmits a URL including a class_name or class identifier component and a method_name or method identifier component (e.g., 410, 510). The URL is received 618 by a server (see FIG. 7) whose server identifier 118 is included in the URL.

The server interprets 622 a first component of the URL as an object class identifier. For example, an application root (e.g., 418) is predefined in the server. The application root (e.g., 418) is included in the received URL. The predefined application root (e.g., hr 418) is recognized as a flag directing the server to invocate a controller or handler program. The controller or handler program examines the received URL and recognizes one of the components of the URL to be an object class identifier (e.g., 422). For example, the URL component matches one of a plurality of Java object class identifiers known to the controller program.

The server also interprets 626 a second component of the URL as a method identifier. For example, the controller or handler program examines the URL and recognizes one of the components as matching one of a plurality of Java method identifiers known to the controller program.

The controller program accesses or instantiates 630 a Java object class associated with the Java object class identifier (e.g., 422). For example, a class of administration tools is instantiated within the server.

A Java method associated with the Java method identifier (e.g., 426, 526) is retrieved or invoked 634 from the accessed or instantiated object class. For example, a dynamic web page listing employees is generated.

In another example, an invoked method generates a form. The form is transmitted to the client. The form allows the user to communicate employee information to the server, thereby adding an employee to the list of employees.

Referring to FIG. 7, a server 710 operative to perform the procedure for providing a resource or provide a client access to information 610 includes a server front end 714, a URL parser 718, a storage device 722, a resource retriever 726 and a resource provider 730. For example, the URL parser 718, resource retriever 726 and resource provider 730 are components of a controller or handler program and/or are implemented in software, hardware or a combination thereof. The server front end 714 includes hardware and software for performing server functions known in the art. Additionally, the server front end 714 includes, or has access to, a list or database of predefined application roots 214, 418 to be used as flags or switches for invoking the URL parser 718. For example, when the server front end 714 receives a URL, the server front end 714 examines the URL to, among other things, determine if the URL includes one of the predetermined application roots. If the URL does not include one of the predetermined application roots, the URL is processed as is known in the art. If the URL does include an application root that matches one of the predetermined application roots known to, or accessible by, the server front end, then the URL is passed to the URL parser 718. For example, the URL parser is operative to extract an object class identifier component (e.g., 218, 422) and a method identifier component (e.g., 222, 426, 526) from the URL. The extracted object class and method identifiers are communicated to the resource retriever 726.

The resource retriever accesses the storage device 722 and retrieves a class associated with the class identifier component. The object class is made available to the resource provider 730.

The resource provider 730 makes the requested resource available to the requesting party. For example, the URL is received over a network 740 from a client application 744, such as a web browser. The resource provider 730 provides the requested resource to the client application 744 via the services of the server front end 714 and the network 740. For instance, the resource provider 730 instantiates the class provided by the resource retriever and executes the method associated with the method identifier component of the URL. Output from the executed method is transmitted to the client application.

In some cases, the client application 744 may provide input into the method. For example, in a first state, output from the method includes a form to be filled out or a selection box. The form or selection box is transmitted to the client 744. A user uses the client 744 to provide the information (i.e., fill out the form or make a selection). The information is then transmitted back to the server 710 over the network 740. The server front end 714 delivers the input to the resource provider 730, which in turn delivers the input to the method. Further output from the method, such as a result based on the input, is transmitted back to the client 714 by the resource provider.

A development system 750 can be used by a system developer to generate and store the object class and one or more methods associated therewith. For instance, the development system stores the object class and its associated methods in the storage device 722. Additionally, the development system can be used to generate a list of predetermined application roots as well as object class and method names or identifiers to be recognized by the server front end 714 and/or the URL parser 718. Alternatively, the predetermined application roots and class and method names or identifiers are stored within the server front 714 and URL parser 718, respectively.

The invention has been described with reference to particular embodiments. Modifications and alterations will occur to others upon reading and understanding the specification. It is intended that all such modifications and alterations are included insofar as they come within the scope of the appended claims or equivalents thereof.

What is claimed is:

1. A procedure operative to provide a resource, the procedure comprising:
receiving, from a client, a URL requesting the resource;
interpreting a first component of the URL as an object class identifier associated with an object class;
interpreting a second component of the URL as a method identifier associated with a method of the object class;
accessing the object class based on the object class identifier;
retrieving the method associated with the method identifier from the object class; and
providing the requested resource based on the retrieved method.

2. The procedure of claim 1 wherein interpreting the first component of the URL comprises:
interpreting a first component of the URL as a Java object class identifier.

3. The procedure of claim 2 wherein interpreting the second component of the URL comprises:
interpreting the second component of the URL as a Java method identifier.

4. The procedure of claim 1 wherein accessing the object class comprises:
opening a file including the object class, the object class including a plurality of methods of the object class.

5. The procedure of claim 1 wherein providing the requested resource comprises:
invoking the retrieved method; and
returning output of the method to the client.

6. The procedure of claim 1 further comprising:
recognizing an application root to be a flag directing the invocation of a handler program operative to analyze the URL.

7. A server operative to provide an object oriented resource to a client, the server comprising:
a URL parser operative to extract an object class identifier component and a method identifier component from a URL received from a client;
a resource retriever operative to receive the object class identifier and the method identifier from the URL parser, open an object class associated with the object class identifier and retrieve a method associated with the method identifier from among a plurality of methods in the opened object class; and;
a resource provider operative to receive the retrieved method from the resource retriever and invoke the method, thereby providing the object oriented resource to the client.

8. The server of claim 7 wherein the URL parser is operative to extract a Java object class identifier component and a Java method identifier component from the received URL.

9. The server of claim 7 wherein the resource retriever is operative to receive a Java object class identifier and a Java method identifier from the URL parser, open a Java object class associated with the Java object class identifier and retrieve a Java method associated with the Java method identifier from among a plurality of Java methods in the opened Java object class.

10. The server of claim 7 wherein the resource provider is operative to receive the retrieved method from the resource retriever, invoke the method, and transmit output of the method to the client.

11. The server of claim 7 wherein the resource provider is operative to receive the retrieved Java method from the resource retriever, use the Java method to generate a dynamic web page and transmit the dynamic web page to the client, thereby providing the object oriented resource to the client.

12. A process for providing a client access to information in a server system through a network, the network using a HyperText Transport Protocol, the process comprising:
storing a Java object class including a plurality of Java methods in the server system;
receiving a URL from the client, the URL including a name of the Java object class and a name of a Java method;
invoking a Java method associated with the name of the Java method; and
returning output of the method to the client.

13. The process of claim 12 wherein invoking the Java method comprises:
instantiating the Java object class associated with the name of the Java object class; and,
executing the Java method.

14. The process of claim 12 further comprising:
recognizing a flag or switch within the URL; and, invoking a handler program based on the recognized flag or switch.
